(19) United States
(12) Patent Application Publication
(10) Pub. No.: US 2013/0327463 A1
(43) Pub. Date: Dec. 12, 2013

(54) JOINING METHOD, JOINING DEVICE AND JOINING SYSTEM

(71) Applicants: Shigenori Kitahara, Koshi-shi (JP); Keizo Hirose, Koshi-shi (JP)

(72) Inventors: Shigenori Kitahara, Koshi-shi (JP); Keizo Hirose, Koshi-shi (JP)

(73) Assignee: TOKYO ELECTRON LIMITED, Tokyo (JP)

(21) Appl. No.: 14/001,449

(22) PCT Filed: Feb. 27, 2012
(86) PCT No.: PCT/JP2012/054752

§ 371 Date: Aug. 23, 2013

(30) Foreign Application Priority Data
Mar. 4, 2011 (JP) 2011-047150

(51) Int. Cl. B32B 37/02; B32B 41/00

(52) U.S. Cl. CPC B32B 37/02; B32B 41/00
USPC 156/64; 156/360

(57) ABSTRACT

Provided is a method of bonding substrates having a same planar shape, which includes: bonding a first substrate adsorbed to a lower surface of a first holding member and a second substrate adsorbed to an upper surface of a second holding member that is disposed below the first holding member; and determining whether a bonding position of the first substrate and the second substrate is acceptable by measuring an outer diameter of an overlapped substrate obtained by bonding the first substrate and the second substrate, wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal.

### TECHNICAL FIELD

The present invention relates to a joining method, a joining device and a joining system, which joins together substrates having the same planar shape.

### BACKGROUND

In recent years, high integration of semiconductor devices has been prompted. However, when a plurality of highly-integrated semiconductor devices is arranged on a horizontal plane and is connected by wires for production, an increase in a wire length increases wire resistance and a wire delay.

To overcome this problem, the use of a three dimensional integration technique has been proposed which stacks semiconductor devices in three dimensions. In the three dimensional integration technique, for example, a joining (or bonding) device is used to bond two semiconductor wafers (hereinafter, referred to as “wafers”) together. The bonding device includes, e.g., a chamber which accommodates two wafers vertically arranged (hereinafter, a wafer positioned at an upper side is referred to as an “upper wafer” and a wafer positioned at a lower side is referred to as a “lower wafer”), a pressing pin provided within the chamber and presses the center of the upper wafer, and a spacer that supports an outer periphery of the upper wafer and is movable backwards from the outer periphery of the upper wafer. In this bonding device, in order to prevent voids from occurring between the two wafers, the two wafers are bonded together inside the chamber exhaust. Specifically, this bonding is performed by first pressing the center of the upper wafer using the pressing pin with the upper wafer supported by the spacer; bring into the center of the upper wafer contact with the lower wafer; moving the spacer supporting the upper wafer back from the upper wafer; and then bring into the entire surface of the upper wafer contact with the entire surface of the lower wafer (see Patent Document 1).

### PRIOR ART DOCUMENT

### Patent Document

Patent Document 1: Japanese laid-open publication No. 2004-207436

However, in the bonding device disclosed in Patent Document 1, when the center of the upper wafer is pressed by the pressing pin, a misalignment of the upper wafer relative to the lower wafer may occur. This is because the upper wafer is supported by only the spacer.

Due to other problems of the bonding device, the wafers may not be stably bonded to each other.

If an attempt is made to transfer the wafers out of the bonding device in a state where the wafers are not stably bonded to each other, a transfer failure may occur. This results in an unstable bonding process for subsequent wafers. In some instances, it may be difficult to transfer the wafers within the bonding device. Under this circumstance, the subsequent wafers to be bonded are transferred into the bonding device, which causes damage to the subsequent wafers.

### SUMMARY

The present invention has been made in consideration of the above points, and in some embodiments, provides a determination of a bonding state of substrates, thus stably performing a subsequent process after the bonding of the substrates.

According to one embodiment of the present invention, provided is a method of bonding substrates having a same planar shape, which includes: bonding a first substrate adsorbed to a lower surface of a first holding member and a second substrate adsorbed to an upper surface of a second holding member that is disposed below the first holding member; and determining whether a bonding position of the first substrate and the second substrate is acceptable by measuring an outer diameter of an overlapped substrate obtained by bonding the first substrate and the second substrate, wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal.

According to some embodiments, the determining measures the outer diameter of the overlapped substrate obtained by bonding a first substrate and a second substrate, and determines whether the bonding position of the first substrate and the second substrate is acceptable. That is, the normality of the bonding of the first substrate and the second substrate is determined When the bonding is determined to be normal, the overlapped substrate is properly subjected to a subsequent process. When the bonding is determined to be abnormal, the overlapped substrate is collected without being subjected to the subsequent process. Thus, it is possible to prevent a transfer failure or wafer damage from occurring unlike the related art, thereby smoothly performing processing for subsequent wafers.

According to another embodiment of the present invention, provided is a bonding device of bonding substrates having the same planar shape, which includes: a first holding member configured to hold a first substrate on its lower surface; a second holding member disposed below the first holding member and configured to hold a second substrate on its upper surface; a measuring unit configured to measure an outer diameter of an overlapped substrate obtained by bonding the first substrate and the second substrate; and a control unit configured to determine whether a bonding of the first substrate and the second substrate is acceptable, wherein the control unit controls the first holding member, the second holding member and the measuring unit to perform: bonding the first substrate adsorbed to the lower surface of the first holding member and the second substrate adsorbed to the upper surface of the second holding member, measuring an outer diameter of the overlapped substrate, and determining whether a bonding position of the first substrate and the second substrate is acceptable based on the measurement result, wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal.

According to another embodiment of the present invention, provided is a bonding system provided with a bonding device of bonding substrates having the same planar shape. The bonding system comprises: the bonding device including: a first holding member configured to hold a first substrate on its lower surface, a second holding member disposed below the first holding member and configured to hold a second substrate on its upper surface, a measuring unit configured to measure an outer diameter of an overlapped substrate obtained by bonding the first substrate and the second substrate, and a control unit configured to determine whether a bonding of the first substrate and the second substrate is acceptable. The control unit controls the first holding member, the second holding member and the measuring unit to perform: bonding the first substrate adsorbed to the lower surface of the first holding member and the second substrate adsorbed to the upper surface of the second holding member, measuring an outer diameter of the overlapped substrate, and determining whether a bonding position of the first substrate and the second substrate is acceptable based on the measurement result, wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal; a processing station including the bonding device; and a carry-in/carry-out station in which the first substrate, the second substrate or the overlapped substrate is accommodated and is carried into/out the processing station. The processing station includes: a surface modification device configured to modify a front surface of the first substrate to be bonded or a front surface of the second substrate to be bonded, a surface hydrophilization device configured to hydrophilize the front surface of the first substrate or the second substrate modified by the surface modification device, and a transfer zone in which the first substrate, the second substrate or the overlapped substrate is transferred between the surface modification device, the surface hydrophilization device and the bonding device. Wherein, the bonding device is configured to bond the first substrate and the second substrate whose front surfaces are hydrophilized by the surface hydrophilization device.

According to the present invention, it is possible to determine a bonding state of substrates, thus stably performing a subsequent process after the bonding of the substrates.

### BRIEF DESCRIPTION OF THE DRAWINGS

FIG. 1 is a plane view schematically showing a configuration of a bonding system according to an embodiment of the present invention.

FIG. 2 is a lateral sectional view schematically showing an internal configuration of the bonding system according to an embodiment of the present invention.

FIG. 3 is a lateral sectional view schematically showing configurations of an upper wafer and a lower wafer.

FIG. 4 is a longitudinal sectional view schematically showing a configuration of a surface modification device.

FIG. 5 is a plane view of a lower electrode. FIG. 6 is a longitudinal sectional view schematically showing a configuration of a surface hydrophilization device.

FIG. 7 is a traverse sectional view schematically showing the configuration of the surface hydrophilization device.

FIG. 8 is a traverse sectional view schematically showing a configuration of a bonding device.

FIG. 9 is a longitudinal sectional view schematically showing the configuration of the bonding device.

FIG. 10 is a lateral sectional view schematically showing a configuration of a position adjusting mechanism.

FIG. 11 is a lateral sectional view schematically showing a configuration of an inverting mechanism.

FIG. 12 is a longitudinal sectional view schematically showing configurations of an upper chuck and a lower chuck.

FIG. 13 is a plane view of the upper chuck when viewed from the bottom.

FIG. 14 is a plane view of the lower chuck when viewed from the top.

FIG. 15 is a flowchart showing main operations of a wafer bonding process.

FIG. 16 is a cross-sectional view showing how horizontal positions of the upper wafer and the lower wafer are adjusted.

FIG. 17 is a cross-sectional view showing how vertical positions of the upper wafer and the lower wafer are adjusted.

FIG. 18 is a cross-sectional view showing how to centers of the upper wafer and the lower wafer are brought into contact with each other and pressed together.

FIG. 19 is a cross-sectional view showing how to the upper wafer and the lower wafer are gradually brought into contact with each other.

FIG. 20 is a cross-sectional view showing how surfaces of the upper wafer and the lower wafer are brought into contact with each other.

FIG. 21 is a cross-sectional view showing a state where the upper wafer and the lower wafer are bonded together.

FIG. 22 is a cross-sectional view showing a state where the upper wafer and the lower wafer are normally bonded.

FIG. 23 is a cross-sectional view showing a state where the upper wafer and the lower wafer are abnormally bonded.

FIG. 24 is a cross-sectional view showing how the lower chuck is moved upward and the lower chuck is disposed at a predetermined position when determining whether a bonding strength of the upper wafer and the lower wafer is acceptable.

FIG. 25 is a cross-sectional view showing a state where the bonding strength of the upper wafer and the lower wafer is normal.

FIG. 26 is a cross-sectional view showing a state where the bonding strength of the upper wafer and the lower wafer is abnormal.

FIG. 27 is a cross-sectional view showing how the lower chuck is moved downward and disposed at a predetermined position when determining whether a bonding position of the upper wafer and the lower wafer is acceptable.

FIG. 28 is a cross-sectional view showing how an image of an outer periphery of an overlapped substrate is picked up.

### DETAILED DESCRIPTION

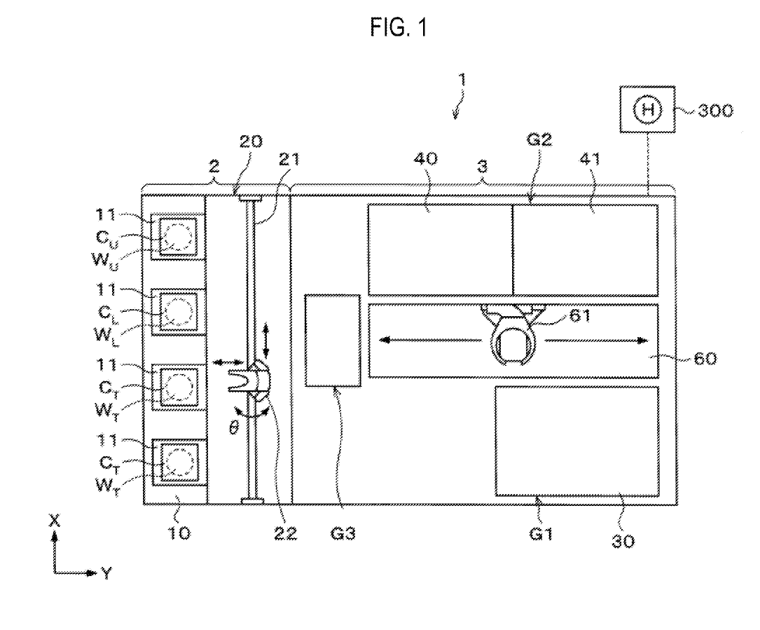

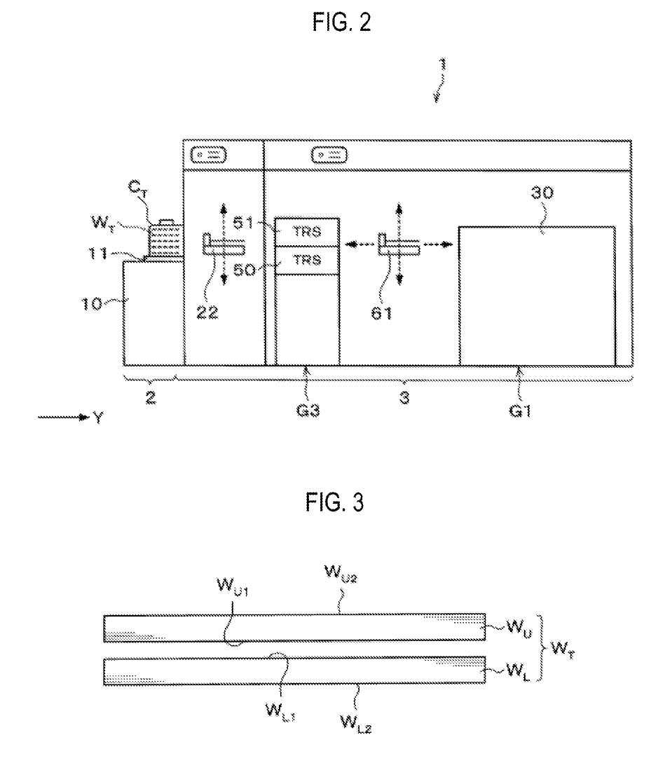

Embodiments of the present invention will now be in detail described with reference to the accompanying drawings. FIG. 1 is a schematic plane view showing a configuration of a bonding system 1 according to one embodiment. FIG. 2 is a schematic lateral sectional view showing an internal configuration of the bonding system 1.

In the bonding system 1, for example, wafers W_{U} and W_{L} are indicated as two substrates that are bonded together as shown in FIG. 3. In the following description, a wafer positioned at the upper side will be referred to as an “upper wafer W_{U}” as a first substrate, and a wafer positioned at the lower side will be referred to as a “lower wafer W_{L}” as a second substrate. In the upper wafer W_{U}, a surface that is bonded to the lower wafer W_{L} will be referred to as a “front surface W_{U1}”, and an opposite surface of the front surface W_{U1} will be referred to as a “rear surface W_{U2}.” Similarly, in the lower wafer W_{L}, a surface that is bonded to the upper wafer W_{U} will be referred to as a “front surface W_{L1}” and an opposite surface of the front surface W_{L1} will be referred to as a “rear surface W_{L2}”. Further, in the bonding system 1, an overlapped wafer W_{T} as an overlapped substrate is obtained by bonding the upper wafer W_{U} and the lower wafer W_{L} together. The upper wafer W_{U} and the lower wafer W_{L} have the same circular shape when viewed from the top. Outer diameters of the upper wafer W_{U} and the lower wafer W_{L} are, e.g., 300 mm, respectively.

As shown in FIG. 1, the bonding system 1 includes a carry-in/carry-out station 2 in which cassettes C_{U}, C_{L}, and C_{T} are carried in and out between the carry-in/carry-out station 2 and the outside, and a processing station 3 including various processing units that are configured to perform a predetermined process on the wafers W_{U}, W_{L} and W_{T}, in which the carry-in/carry-out station 2 and the processing station 3 are connected serially. The cassettes C_{U}, C_{L}, and C_{T} are configured to accommodate a plurality of wafers W_{U} and W_{L}, and a plurality of overlapped wafers W_{T} therein, respectively.

A cassette loading table 10 is disposed in the carry-in/carry-out station 2. A plurality of (e.g., four) cassette loading boards 11 are loaded on the cassette loading table 10. The cassette loading boards 11 are arranged in a line along an X-axis direction (vertical direction in FIG. 1). The cassette loading boards 11 can load thereon the cassettes C_{U}, C_{L} and C_{T}, when they are carried in and out between the carry-in/carry-out station 2 and the outside of the bonding system 1, respectively. In this way, the carry-in/carry-out station 2 can hold the plurality of upper wafers W_{U}, the plurality of lower wafers W_{L} and the plurality of overlapped wafers W_{T}. The number of the cassette loading boards 11 is not limited to this embodiment but may be designed as appropriate. One of the cassettes may be used as a collection cassette for collecting defective wafers. That is, the collection cassette is provided to receive the defective wafers having a defect due to various factors in the bonding of the upper wafer W_{U} and the lower wafer W_{L}, except normal overlapped wafers W_{T}. In this embodiment, one of the plurality of cassettes C_{T} is used as the collection cassette for collecting the defective wafers, and the other cassettes C_{T} are used to receive the normal overlapped wafers W_{T}.

In the carry-in/carry-out station 2, a wafer transfer section 20 is disposed adjacent to the cassette loading table 10. The wafer transfer section 20 is provided with a wafer transfer unit 22 which is movable along a transfer path 21 extending in the X-axis direction. The wafer transfer unit 22, which is movable in a vertical direction and is also rotatable around a vertical axis (or in θ direction), transfers the wafer W_{U}, the wafer W_{L} and the overlapped wafer W_{T} between the cassettes C_{U}, C_{L} and C_{T} loaded on the respective cassette loading boards 11, and transition units 51 and 52 of a third processing block G3 of the processing station 3, which will be described later.

The processing station 3 is provided with a plurality of (e.g., three) processing blocks G1, G2 and G3, which include various processing units. For example, the first processing block G1 is disposed at the front side of the processing station 3 in the X-axis direction (at the lower side in FIG. 1). The second processing block G2 is disposed at the back side of the processing station 3 in the X-axis direction (at the upper side in FIG. 1). The third processing block G3 is disposed in the vicinity of the carry-in/carry-out station 2 (at the back side of the processing station 3 in a Y-axis direction in FIG. 1).

The first processing block G1 is provided with, e.g., a surface modification device 30 configured to modify the front surfaces W_{U1} and W_{L1} of the wafers W_{U} and W_{L}.

The second processing block G2 is provided with a surface hydrophilization device 40 configured to hydrophilize and clean the front surfaces W_{U1} and W_{L1} of the wafers W_{U} and W_{L} with, e.g., pure water, and a bonding device 41 configured to bond the wafers W_{U} and W_{L} together, which are arranged from the carry-in/carry-out station 2 in the Y-axis direction in that order.

The third processing block G3 is provided with the transition units 50 and 51 configured to transit the wafers W_{U} and W_{L} and the overlapped wafer W_{T}, which are stacked in two stages in order from the bottom, as shown in FIG. 2.

As shown in FIG. 1, an area which is bounded by the first to third processing blocks G1 to G3 is defined as a wafer transfer zone 60. For example, a wafer transfer unit 61 is disposed in the wafer transfer zone 60.

The wafer transfer unit 61 is equipped with a transfer arm (not shown) which is movable in a vertical direction, horizontal directions (the X and Y-axis directions) and is rotatable around a vertical axis. The wafer transfer unit 61 moves inside the wafer transfer zone 60 so that the wafers W_{U} and W_{L} and the overlapped wafer W_{T} are transferred to a respective processing unit installed in each of the first to third processing blocks G1, G2 and G3.

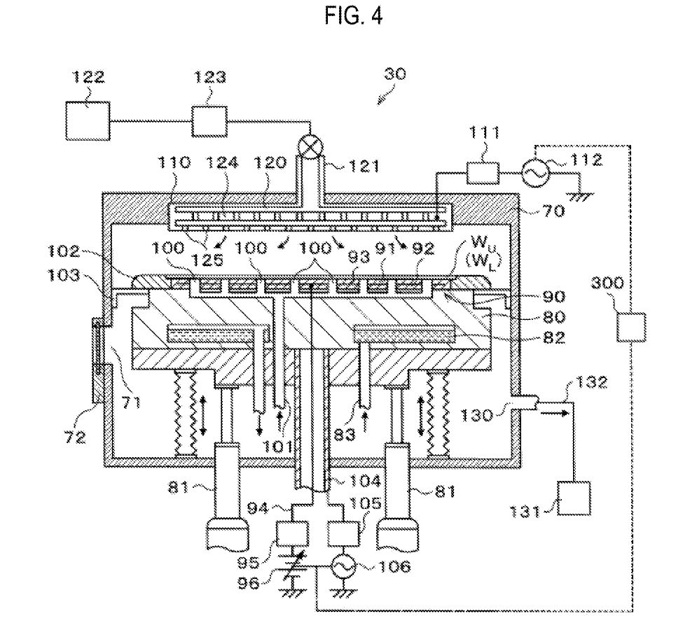

Next, a configuration of the abovementioned surface modification device 30 will be described. As shown in FIG. 4, the surface modification device 30 includes an internally-sealable processing vessel 70. An inlet/outlet 71 through which the wafers W_{U} and W_{L} are transferred is formed in the side of the processing vessel 70 facing the wafer transfer region 60 and a gate valve 72 is provided at the inlet/outlet 71.

A lower electrode 80 on which the wafer W_{U} (or W_{L}) is mounted is installed inside the processing vessel 70. The lower electrode 80 is made of an electrically conductive material, e.g., aluminum. A drive unit 81 equipped with, e.g., a motor, is installed below the lower electrode 80. The lower electrode 80 is movable up and down by operating the drive unit 81.

A heat medium circulation flow path 82 is formed within the lower electrode 80. A heat medium whose temperature is controlled to a suitable temperature by a temperature control unit (not shown), is introduced into the heat medium circulation flow path 82 through a heat medium introduction pipe 83. The heat medium introduced through the heat medium introduction pipe 83 circulates through the heat medium circulation flow path 82 so that a temperature of the lower electrode 80 is controlled to a desired temperature. The heat of the lower electrode 80 is transferred to the wafer W_{U} (or W_{L}) mounted on the upper surface of the lower electrode 80 so that the temperature of the wafer W_{U} (or W_{L}) is controlled to a desired temperature.

A temperature control mechanism which controls the temperature of the lower electrode 80 is not limited to the heat medium circulation flow path 82 but other temperature control mechanisms including a cooling jacket, a heater or the like may be used.

An upper portion of the lower electrode 80 constitutes an electrostatic chuck 90 configured to electrostatically adsorb the wafer W_{U} (or W_{L}). The electrostatic chuck 90 has a structure in which a conductive film 93, e.g., a copper foil, is disposed between two films 91 and 92 made of a polymeric insulating material such as a polyimide resin or the like. The conductive film 93 is connected to a high-voltage power supply 96 through a wiring line 94 and a filter 95 such as a coil. During plasma processing, a high voltage set to an arbitrary DC voltage is applied from the high-voltage power supply 96 to the conductive film 93 while cutting out high-frequency by the filter 95. By virtue of a Coulomb force generated by the high voltage applied to the conductive film 93 in this manner, the wafer W_{U} (or W_{L}) is electrostatically adsorbed to the upper surface of the lower electrode 80 (i.e., the upper surface of the electrostatic chuck 90).

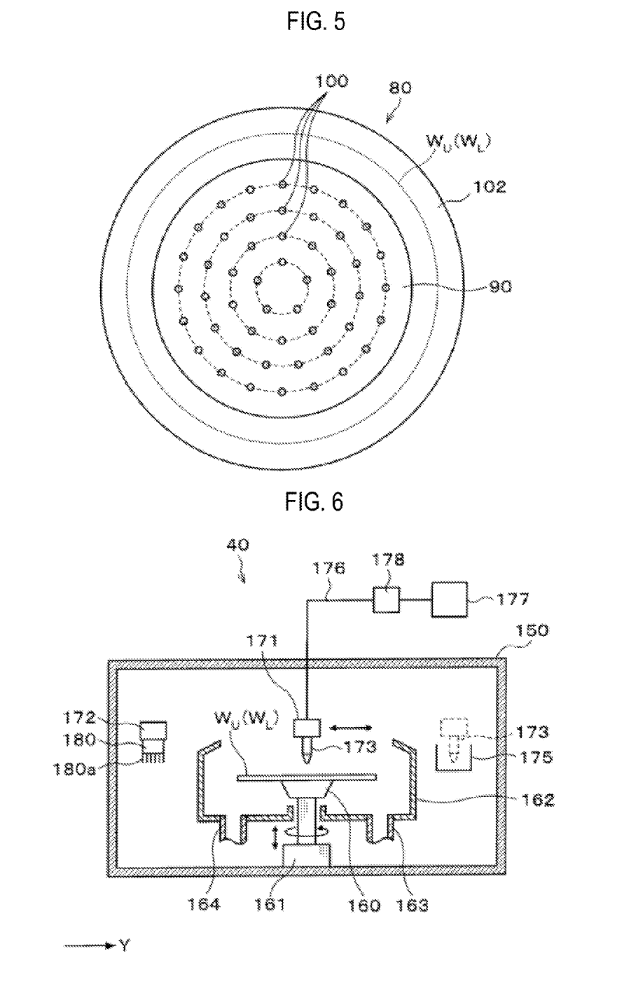

A plurality of heat transfer gas supply holes 100 through which a heat transfer gas is supplied toward the rear surface of the wafer W_{U} (or W_{L}) are formed on the upper surface of the lower electrode 80. As shown in FIG. 5, the heat transfer gas supply holes 100 are evenly arranged along a plurality of concentric circles on the upper surface of the lower electrode 80.

As shown in FIG. 4, a heat transfer gas supply pipe 101 is connected to the heat transfer gas supply holes 100. The heat transfer gas supply pipe 101 is connected to a gas supply source (not shown) such that a heat transfer gas (e.g., helium) supplied from the gas supply source is supplied into a fine space defined between the upper surface of the lower electrode 80 and the rear surface W_{U2} (or W_{L2}) of the wafer W_{U} (or W_{L}). Thus, heat is efficiently transferred from the upper surface of the lower electrode 80 to the wafer W_{U} (or W_{L}).

The heat transfer gas supply holes 100 and the heat transfer gas supply pipe 101 may be omitted as long as the heat is transferred to the wafer W_{U} (or W_{L}) in a highly efficient manner.

An annular focus ring 102 is disposed around the upper surface of the lower electrode 80 so as to surround the outer periphery of the wafer W_{U} (or W_{L}) mounted on the lower electrode 80. The focus ring 102 is made of an insulating or conductive material not adsorbing reactive ions. The focus ring 102 allows the reactive ions to be efficiently impinged onto only the wafer W_{U} (or W_{L}) positioned inside the focus ring 102.

An exhaust ring 103 with a plurality of baffle holes formed therein is disposed between the lower electrode 80 and an inner wall of the processing vessel 70. The exhaust ring 103 allows an internal atmosphere of the processing vessel 70 to be uniformly discharged.

A power supply rod 104 formed of a hollow conductor is connected to a lower surface of the lower electrode 80. The power supply rod 104A is connected to a first high-frequency power supply 106 through a matching unit 105 made of, e.g., a blocking capacitor. During plasma processing, a high-frequency voltage of, e.g., 13.56 MHz, is applied from the first high-frequency power supply 106 to the lower electrode 80.

An upper electrode 110 is disposed above the lower electrode 80. The upper surface of the lower electrode 80 and a lower surface of the upper electrode 110 are disposed in parallel while facing each other with a predetermined gap left therebetween. The gap between the upper surface of the lower electrode 80 and the lower surface of the upper electrode 110 is adjusted by the drive unit 81.

The upper electrode 110 is configured to a second high-frequency power supply 112 through a matching unit 111 made of, e.g., a blocking capacitor. During plasma processing, a high-frequency voltage of, e.g., 100 MHz, is applied from the second high-frequency power supply 112 to the upper electrode 110. The application of the high-frequency voltage from each of the first high-frequency power supply 106 and the second high-frequency power supply 112 to each of the lower electrode 80 and the upper electrode 110 generates plasma within the processing vessel 70.

The high-voltage power supply 96 configured to apply the high voltage to the conductive film 93 of the electrostatic chuck 90, the first high-frequency power supply 106 configured to apply the high-frequency voltage to the lower electrode 80, and the second high-frequency power supply 112 configured to apply the high-frequency voltage to the upper electrode 110 are controlled by a control unit 300, which will be described later.

A hollow portion 120 is formed within the upper electrode 110. The hollow portion 120A is configured to a gas supply pipe 121. The gas supply pipe 121 is connected to a gas supply source 122 configured to store a process gas therein. A supply kit 123 including a valve or a flow rate regulator configured to control a flow of the process gas is installed in the gas supply pipe 121. A flow rate of the process gas supplied from the gas supply source 122 is controlled by the supply kit 123. The flow rate-controlled process gas is introduced into the hollow portion 120 of the upper electrode 110 through the gas supply pipe 121. For example, an oxygen gas, a nitrogen gas or an argon gas may be used as the process gas.

A baffle plate 124 configured to facilitate a uniform diffusion of the process gas is installed within the hollow portion 120. A multiplicity of small holes is formed in the baffle plate 124. A plurality of gas injection holes 125 through which the process gas is injected from the hollow portion 120 into the processing vessel 70 is formed on the lower surface of the upper electrode 110.

A suction port 130 is formed in a lower portion of the processing vessel 70. The suction port 130 is connected to a suction pile 132, which is in communication with a vacuum pump 131 configured to reduce the internal atmosphere of the processing vessel 70 to a predetermined degree of vacuum.

A plurality of elevating pins (not shown) which elevates the wafer W_{U} (or W_{L}) supported from bottom is disposed below the lower electrode 80. The elevating pins are inserted through throughholes (not shown) formed in the lower electrode 80 in such a manner that they project from the top of the lower electrode 80.

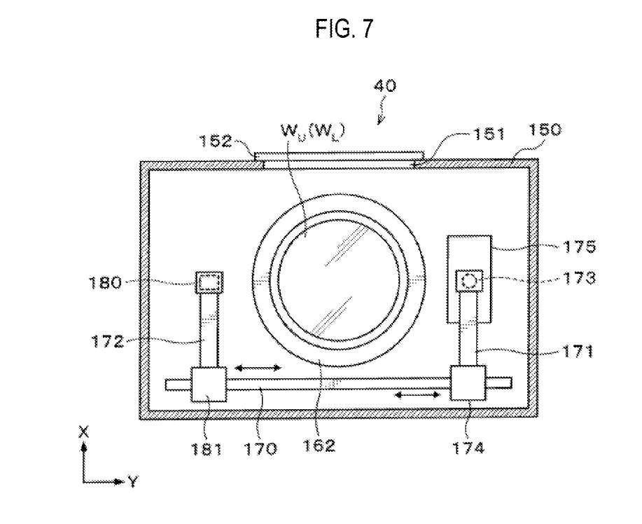

Next, a configuration of the aforementioned surface hydrophilization device 40 will be described. As shown in FIG. 6, the surface hydrophilization device 40 includes an internally-sealable processing vessel 150. As shown in FIG. 7, an inlet/outlet 151 through which the wafer W_{U} (or W_{L}) is transferred is formed at a lateral side facing the wafer transfer zone 60 in the processing vessel 150, and an opening/closing shutter 152 is disposed in the inlet/outlet 151.

As shown in FIG. 6, a spin chuck 160 configured to hold and rotate the wafer W_{U} (or W_{L}) is disposed in a central portion inside the processing vessel 150. The spin chuck 160 includes a horizontal upper surface on which, e.g., suction holes (not shown) for suctioning the wafer W_{U} (or W_{L}) are formed. Using the suction force of the suction holes, the spin chuck 160 can adsorb the wafer W_{U} (or W_{L}).

A chuck drive unit 161 equipped with, e.g., a motor, is installed below the spin chuck 160. The spin chuck 160 can be rotated at a predetermined speed by the chuck drive unit 161. The chuck drive unit 161 is provided with an up-down drive source (not shown) such as a cylinder or the like and can move the spin chuck 160 up and down. In some embodiments, a cup 162 (which will be described later) may be configured to move up and down.

The cup 162 is provided around the spin chuck 160 to receive and collect liquid dropped or scattered from the wafer W_{U} (or W_{L}). A bottom surface of the cup 162 is connected to a discharge pipe 163 configured to drain the collected liquid and an exhaust pipe 164 configured to exhaust gas from the cup 322 and discharge an atmosphere therewithin.

As shown in FIG. 7, a rail 170 extending in the Y-axis direction (the left-right direction in FIG. 7) is formed at the back side of the cup 162 in the X-axis direction (at the lower side in FIG. 7). The rail 170 extends at the outer side of the cup 162 from the back side (the left side in FIG. 7) to the front side (the right side in FIG. 7) of the cup 162 in the Y-axis direction, for example. A nozzle arm 171 and a scrub arm 172 are mounted in the rail 172.

As shown in FIGS. 6 and 7, the nozzle arm 171 supports a pure water nozzle 173 configured to supply pure water to the wafer W_{U} (or W_{L}). As shown in FIG. 7, the nozzle arm 171 is movable along the rail 170 by a nozzle drive unit 174. With this configuration, the pure water nozzle 173 is movable from a standby section 175 provided at the front of the outer side of the cup 162 in the Y-axis direction up to above the central portion of the wafer W_{U} (or W_{L}) positioned within the cup 162, and also is movable above the wafer W_{U} (or W_{L}) in the diameter direction of the wafer W_{U} (or W_{L}). The nozzle arm 171 is freely moved up and down by operating the nozzle drive unit 174 to adjust the height of the pure water nozzle 173.

As shown in FIG. 6, the pure water nozzle 173 is connected to a supply pipe 176 configured to supply the pure water to the pure water nozzle 173. The supply pipe 176 is connected to a pure water supply source 177 to store the pure water therein. Further, a supply kit 178 including a valve, a flow rate regulator or the like, which controls a flow of the pure water, is installed in the supply pipe 176.

The scrub arm 172 supports a scrub cleaning tool 180. For example, a plurality of brushes 180a having a string-like or a sponge-like are formed at a leading end of the scrub cleaning tool 180. The scrub arm 172 is movable along the rail 170 by operating a cleaning tool drive unit 181 as shown in FIG. 7. With this configuration, the scrub cleaning tool 180 is movable from the back of the outer side of the cup 162 in the Y-axis direction up to above the central portion of the wafer W_{U} (or W_{L}) positioned within the cup 162. Further, the scrub arm 172 is freely moved up and down by the cleaning tool drive unit 181 to adjust the height of the scrub cleaning tool 180. The scrub cleaning tool 180 is not limited to this embodiment but may be a two-fluid spray nozzle or a jig configured to perform a magasonic cleaning, for example.

In the above configuration, the pure water nozzle 173 and the scrub cleaning tool 180 have been described to be supported by their respective arms 171 and 172, but may be supported by a single arm. In one embodiment, the pure water may be supplied from the scrub cleaning tool 180 without the pure water nozzle 173. In some embodiments, a discharge pipe to discharge the liquid and an exhaust pipe to exhaust the internal atmosphere of the processing vessel 150 may be connected to the bottom surface of the processing vessel 150, without the cup 162. In some embodiments, the surface hydrophilization device 40 as configured as above may include an antistatic ionizer (not shown).

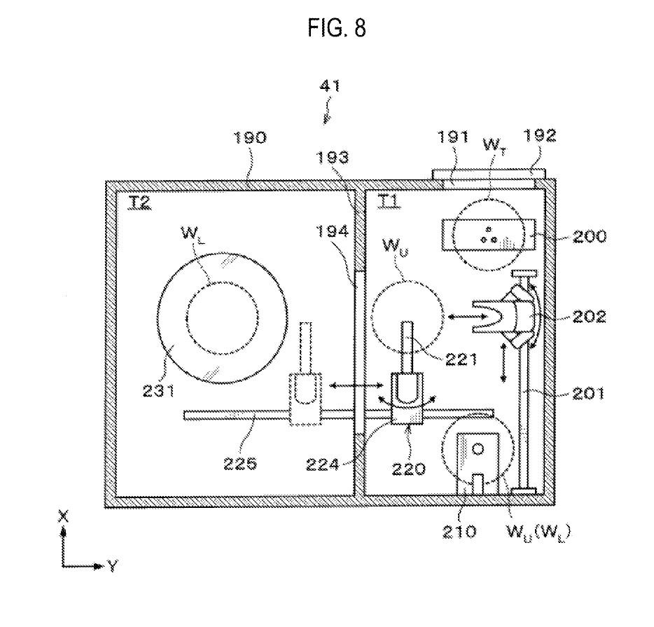

Next, a configuration of the abovementioned bonding device 41 will be described. As shown in FIG. 8, the bonding device 41 includes an internally-sealable processing vessel 190. An inlet/outlet 191, through which the wafer W_{U} (or W_{L}) and the overlapped wafer W_{T} are transferred, is formed at a lateral side facing the wafer transfer zone 60 in the processing vessel 190, and an opening/closing shutter 192 is provided in the inlet/outlet 191.

The interior of the processing vessel 190 is partitioned into a transfer region T1 and a processing region T2 by an internal wall 193. The inlet/outlet 191 as described above is formed in a lateral side of the processing vessel 190 facing the wafer transfer zone 60 in the transfer region T1. Further, an inlet/outlet 194, through which the wafer W_{U} (or W_{L}) and the overlapped wafer W_{T} are transferred, is formed in the internal wall 193.

A transition 200, on which the wafer W_{U} (or W_{L}) and the overlapped wafer W_{T} are temporarily loaded, is formed in the forward side (the top side in FIG. 8) of the transfer region T1 in the X-axis direction. The transition 200 is formed in, e.g., two stages to simultaneously load any two of the wafers W_{U} and W_{L} and the overlapped wafer W_{T} thereon.

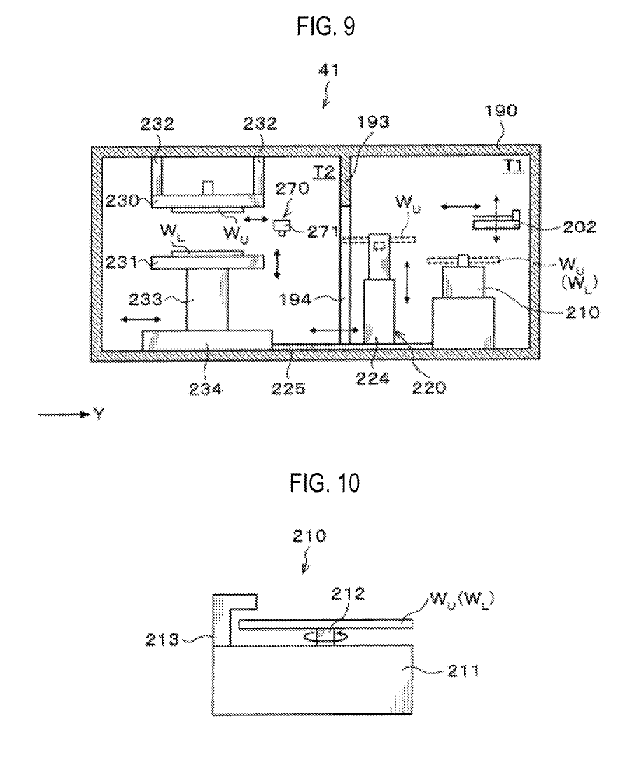

In the transfer region T1, there is installed a wafer transfer body 202 that is movable along a transfer rail 201 extending in the X-axis direction. As shown in FIGS. 8 and 9, the wafer transfer body 202 is movable in the vertical direction and is rotatable around a vertical axis. The wafer transfer body 202 can transfer the wafer W_{U} (or W_{L}) and the overlapped wafer W_{T} within the transfer region T1 or between the transfer region T1 and the processing region T2. In this embodiment, the transfer rail 201 and the wafer transfer body 202 constitute a transfer mechanism.

A position adjusting mechanism 210 configured to adjust a horizontal orientation of the wafer W_{U} (or W_{L}) is disposed at the back side of the transfer region Ti in the X-axis direction. As shown in FIG. 10, the position adjusting mechanism 210 is equipped with a base table 211, a holding unit 212 configured to adsorb and rotate the wafer W_{U} (or W_{L}), and a detection unit 213 configured to detect a position of a notch portion formed in the wafer W_{U} (or W_{L}). In the position adjusting mechanism 210, the detection unit 213 detects the position of the notch portion of the wafer W_{U} (or W_{L}), while rotating the wafer W_{U} (or W_{L}) that is adsorbed to the holding unit 212 such that the position of the notch portion is adjusted. Thus, the position adjusting mechanism 210 adjusts the horizontal orientation of the wafer W_{U} (or W_{L}).

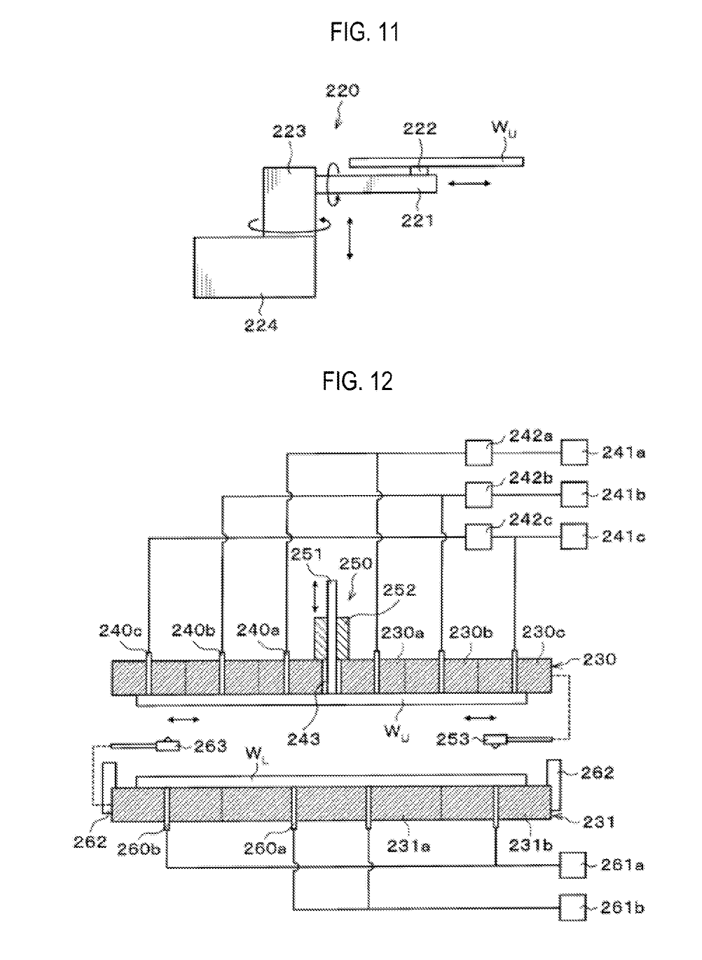

An inverting mechanism 220 configured to move between the transfer region T1 and the processing region T2 and invert the front and rear surfaces of the upper wafer W_{U}, is installed in the transfer region T1. As shown in FIG. 11, the inverting mechanism 220 includes a holding arm 221 configured to hold the upper wafer W_{U}. An adsorption pad 222 configured to adsorb and horizontally hold the upper wafer W_{U} is installed on the holding arm 221. The holding arm 221 is supported by a first drive unit 223. The holding arm 221 is rotatable around a horizontal axis and is horizontally displaceable by operating the first drive unit 223. A second drive unit 224 is installed below the first drive unit 223. By virtue of the second drive unit 224, the first drive unit 223 is rotatable around a vertical axis and is vertically movable. The second drive unit 224 is installed on a rail 225 extending in the Y-axis direction as shown in FIGS. 8 and 9. The rail 225 is disposed to extend from the processing region T2 to the transfer region T1. By virtue of the second drive unit 224, the inverting mechanism 220 is configured to move along the rail 225 between the position adjusting mechanism 210 and an upper chuck 230 (which will be described later). The inverting mechanism 220 serves also as a transfer mechanism for transferring the wafer W_{U} (or W_{L}) and the overlapped wafer W_{T}. The configuration of the inverting mechanism 220 is not limited to this embodiment. As an example, other configurations may be employed as long as it is possible to invert the front and rear surfaces of the upper wafer W_{U}. In some embodiments, the inverting mechanism 220 may be installed in the processing region T2. Further, alternatively, an inverting unit may be provided to the wafer transfer body 202 and an additional transfer unit may be installed in the position of the inverting mechanism 220. Further, alternatively, an inverting unit may be provided to the position adjusting mechanism 210 and an additional transfer unit may be installed in the position of the inverting mechanism 220.

As shown in FIGS. 8 and 9, the upper chuck 230 as a first holding member configured to hold the upper wafer W_{U} on its bottom surface and a lower chuck 231 as a second holding member configured to hold the lower wafer W_{L} on its upper surface are provided in the processing region T2. The lower chuck 231 is disposed below the upper chuck 230 while being positioned to face the upper chuck 230. That is, the upper wafer W_{U} held by the upper chuck 230 and the lower wafer W_{L} held by the lower chuck 231 are disposed opposite to each other.

As shown in FIG. 9, the upper chuck 230 is supported by support members 232 installed in the ceiling of the processing vessel 190. The support members 232 support the periphery of the upper surface of the upper chuck 230. A chuck drive unit 234 is installed below the lower chuck 231 via a shaft 233. The chuck drive unit 234 is configured to move the lower chuck 231 both vertical and horizontal directions. Further, the chuck drive unit 234 is configured to rotate the lower chuck 231 around a vertical axis. In addition, a plurality of elevating pins (not shown) which elevates the lower wafer W_{L} supported from the bottom are disposed below the lower chuck 231. These elevating pins are inserted through through-holes (not shown) formed in the lower chuck 231 in such a manner that they project from the upper surface of the lower chuck 231. In this embodiment, the shaft 233 and the chuck drive unit 234 constitutes an elevating mechanism.

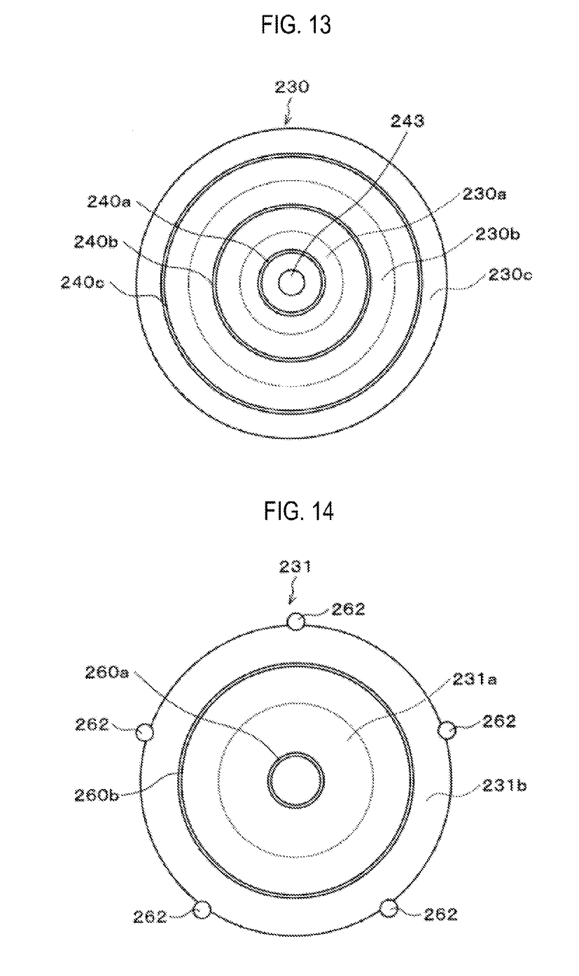

As shown in FIG. 12, the upper chuck 230 is configured to include a plurality of (e.g., three) partitioned regions 230a, 230b and 230c. As shown in FIG. 13, the regions 230a, 230b and 230c are arranged from the center toward the periphery of the upper chuck 230 in that order. The region 230a is of a circular shape and the regions 230b and 230c are of an annular shape, when viewed from the top. As shown in FIG. 12, the regions 230a, 230b and 230c includes respective suction pipes 240a, 240b and 240c which are configured to adsorb the upper wafer W_{U}, respectively. Each of the suction pipes 240a, 240b and 240c are connected to different vacuum pumps 241a, 241b and 241c used as suction mechanisms. Pressure measuring units 242a, 242b and 242c, which are configured to measure internal pressures of the respective suction pipes 240a, 240b and 240c, are installed in the respective suction pipes 240a, 240b and 240c. Thus, the upper chuck 230 is capable of adsorbing the upper wafer W_{U} in the regions 230a, 230b and 230c.

In the following description, each of the regions 230a, 230b and 230c will be sometimes referred to as a first region 230a, a second region 230b and a third region 230c. Further, each of the suction pipes 240a, 240b and 240c will be sometimes referred to as a first suction pipe 240a, a second suction pipe 240b and a third suction pipe 240c. In addition, each of the vacuum pumps 241a, 241b and 241c will be sometimes referred to as a first vacuum pump 241a, a second vacuum pump 241b and a third vacuum pump 241c. Further, each of the pressure measuring units 242a, 242b and 242c will be sometimes referred to as a first pressure measuring unit 242a, a second pressure measuring unit 242b and a third pressure measuring unit 242c.

A through-hole 243 passing through the upper chuck 230 in its thickness direction is formed in a central portion of the upper chuck 230. The central portion of the upper chuck 230 corresponds to the central portion of the upper wafer W_{U} adsorbed to the upper chuck 230. A pressing pin 251 of a pressing member 250 (which will be described later) inserts through the through-hole 243.

The pressing member 250 configured to press the central portion of the upper wafer W_{U} is disposed on the upper surface of the upper chuck 230. The pressing member 250 is of a cylindrical shape and includes the pressing pin 251 and an outer tube 252 acting as a guide when the pressing pin 251 is elevated. The pressing pin 251 is configured to insert through the through-hole 243 and vertically move by a drive unit (not shown) equipped with, e.g., a motor. Further, the pressing member 250 is configured to press the central portion of the upper wafer W_{U} and the central portion of the lower wafer W_{L} while being brought into them contact with each other, when the upper wafer W_{U} and the lower wafer W_{L} are bonded together, which will be described later.

An upper image pickup member 253 configured to pick up an image of the front surface W_{L1} of the lower wafer W_{L} is disposed in the upper chuck 230. Examples of the upper image pickup member 253 may include a wide-angle CCD (Charge-Coupled Device) camera. In some embodiments, the upper image pickup member 253 may be disposed above the upper chuck 230.

As shown in FIG. 14, the lower chuck 231 is configured to have a plurality of (e.g., two) partitioned regions 231a and 231b. These regions 231a and 231b are arranged from the center toward the periphery of the lower chuck 231 in that order. The region 231a is of a circular shape and the region 231b is of an annular shape, when viewed from the top. As shown in FIG. 12, the regions 231a and 231b include respective suction pipes 260a and 260b which are configured to adsorb the lower wafer W_{L}, respectively. Each of the suction pipes 260a and 260b are connected to different vacuum pumps 261a and 261b. Thus, the lower chuck 231 is capable of adsorbing the lower wafer W_{L} in the regions 231a and 231b.

At the periphery of the lower chuck 231 are disposed stopper members 262 configured to prevent the wafers W_{U}, W_{L} or W_{T} from jumping out or slipping from the lower chuck 231. The stopper members 262 are formed to vertically extend upward in such a manner that their top sides are positioned at a higher position than the overlapped wafer W_{T} loaded on the lower chuck 231. In this embodiment, as shown in FIG. 14, the stopper members 262 are disposed at five places in the periphery of the lower chuck 231.

As shown in FIG. 12, a lower image pickup member 263 configured to pick up an image of the front surface W_{U1} of the upper wafer W_{U} is disposed in the lower chuck 231. Examples of the lower image pickup member 263 may include a wide-angle CCD camera. In some embodiments, the lower image pickup member 263 may be disposed above the lower chuck 231.

As shown in FIG. 9, a measuring unit 270, which is configured to measure an outer diameter of the overlapped wafer W_{T} held by the lower chuck 231, is installed in the processing region T2. The measuring unit 270 includes an image pick up unit 271 configured to pick up an image of an outer periphery of the overlapped wafer W_{T}. For example, a micro-camera may be used as the image pick up unit 271. The image pick up unit 271 is horizontally movable by a moving mechanism (not shown).

The bonding system 1 includes the control unit 300 as shown in FIG. 1. The control unit 300 is, for example, a computer and includes a program storage (not shown). The program storage stores a program which controls processing of the wafers W_{U} and W_{L}, and the overlapped wafer W_{T} in the bonding system 1. The program storage also stores a program which controls operation of a driving system including the above-described processing units and transfer units to implement a bonding process in a bonding system 1, which will be described below. Further, the program storage stores a program which determines whether a bonding of the wafers W_{U} and W_{L} performed by the bonding device 41 is acceptable. The programs may be installed in the control unit 300 from a computer readable storage medium H such as, for example, a hard disk (HD), a flexible disk (FD), a compact disk (CD), a magneto-optical disk (MO), a memory card or the like.

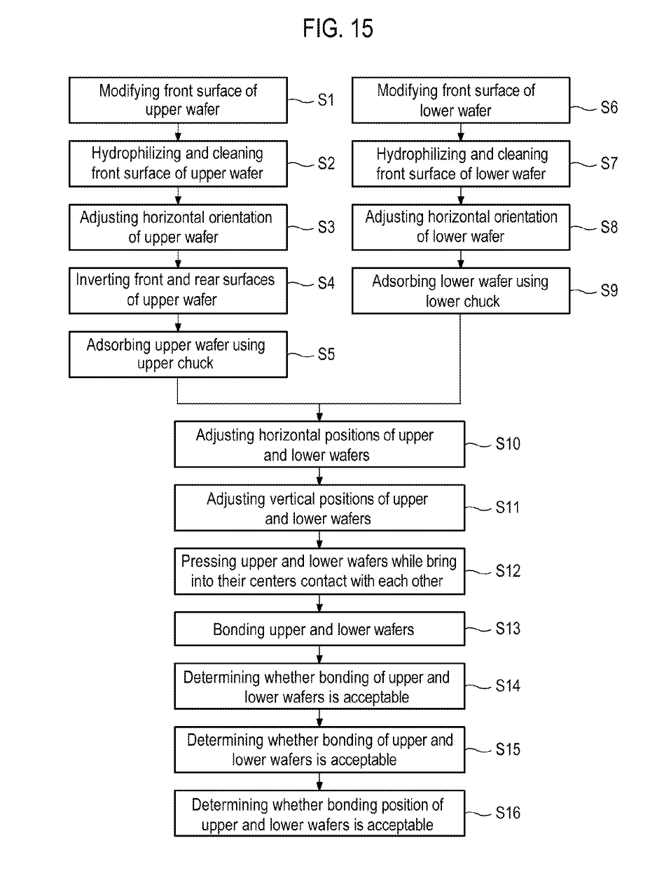

Next, a bonding process of the wafers W_{U} and W_{L} using the bonding system 1 configured as above will be described. FIG. 15 is a flow chart showing main operations of the bonding process.

First, the cassette C_{U} with a plurality of upper wafers W_{U}, a cassette C_{L} with a plurality of lower wafers W_{L}, and an empty cassette C_{T} are loaded on a respective cassette loading board 11 of the carry-in/carry-out station 2. Thereafter, the upper wafer W_{U} within the cassette C_{U} is taken out by the wafer transfer unit 22 and subsequently, is transferred to the transition unit 50 of the third processing block G3 of the processing station 3.

Subsequently, the upper wafer W_{U} is transferred to the surface modification device 30 of the first processing block G1 by the wafer transfer unit 61. The upper wafer W_{U} transferred to the surface modification device 30 is loaded on the upper surface of the lower electrode 80 by the wafer transfer unit 61. Thereafter, the wafer transfer unit 61 is retreated from the surface modification device 30 and the gate valve 72 is closed.

Thereafter, the vacuum pump 131 is operated to reduce an internal atmosphere of the processing vessel 70 to a predetermined degree of vacuum, for example, 6.7 to 66.7 Pa (50 to 500 mTorr) through the air suction hole 130. Then, the internal atmosphere of the processing vessel 100 is kept at the predetermined degree of vacuum during the processing of the upper wafer W_{U}, as will be described later.

A high voltage set to a DC voltage of, e.g., 2500 V, is applied from the high-voltage power supply 96 to the conductive film 93 of the electrostatic chuck 90. By virtue of the Coulomb force generated by the high voltage applied to the electrostatic chuck 90 in this manner, the upper wafer W_{U} is electrostatically adsorbed to the upper surface of the lower electrode 80. The upper wafer W_{U} electrostatically adsorbed to lower electrode 80 is maintained at a predetermined temperature, e.g., 20 to 30 degrees C., by the heat medium flowing through the heat medium circulation flow path 82.

Thereafter, the process gas coming from the gas supply source 122 is evenly supplied into the processing vessel 70 through the gas injection holes 125 formed in the lower surface of the upper electrode 110. A high-frequency voltage of, e.g., 13.56 MHz, is applied from the first high-frequency power supply 106 to the lower electrode 80. Further, a high-frequency voltage of, e.g., 100 MHz, is applied from the second high-frequency power supply 112 to the upper electrode 110. These applications cause an electric field between the upper electrode 110 and the lower electrode 80 so that the process gas supplied into the processing vessel 70 is plasmarized.

The plasma of the process gas (hereinafter often referred to as “processing plasma”) modifies the front surface W_{U1} of the upper wafer W_{U} mounted on the lower electrode 80 and removes organic materials existing thereon. At this time, an oxygen plasma gas of the processing plasma is mainly used in removing the organic materials existing on the front surface W_{U1} The oxygen plasma gas facilitates the oxidization, i.e., hydrophilization, of the front surface W_{U1} of the upper wafer W_{U}. The oxygen plasma gas of the processing plasma has a higher level of energy so that the organic materials existing on the front surface W_{U1} are actively (physically) removed. Further, the oxygen plasma gas has an effect of removing residual moisture contained in the internal atmosphere of the processing vessel 70. In this way, the front surface W_{U1} of the upper wafer W_{U} is modified by the processing plasma (Operation S1 in FIG. 15).

Subsequently, the upper wafer W_{U} is transferred to the surface hydrophilization device 40 of the second processing block G2 by the wafer transfer unit 61. The upper wafer W_{U} transferred to the surface hydrophilization device 40 is delivered to the spin chuck 160 by the wafer transfer unit 61 and be adsorbed to the spin chuck 160.

Subsequently, the pure water nozzle 173 positioned within the standby section 175 is moved to the central portion of the upper wafer W_{U} by the nozzle arm 171, and the scrub cleaning tool 180 is moved above the upper wafer W_{U} by the scrub arm 172. Thereafter, pure water is supplied from the pure water nozzle 173 onto the upper wafer W_{U} while rotating the upper wafer W_{U} by the spin chuck 160. Thus, a hydroxyl group is adhered onto the front surface W_{U1} of the upper wafer W_{U} so that the front surface W_{U1} is hydrophilized. Further, the front surface W_{U1} of the upper wafer W_{U} is cleaned by the scrub cleaning tool 180 and the pure water supplied from the pure water nozzle 173 (Operation S2 in FIG. 15).

Subsequently, the upper wafer W_{U} is transferred to the bonding device 41 of the second processing block G2 by the wafer transfer unit 61. In the bonding device 41, the upper wafer W_{U} is transferred to the position adjusting mechanism 210 by the wafer transfer body 202 via the transition 200. In the position adjusting mechanism 210, a horizontal orientation of the upper wafer W_{U} is adjusted (Operation S3 in FIG. 15).

Thereafter, the upper wafer W_{U} is moved from the position adjusting mechanism 210 to the holding arm 221 of the inverting mechanism 220. Subsequently, in the transfer region T1, the holding arm 221 is inverted such that the front and rear surfaces of the upper wafer W_{U} are inverted upside down (Operation S4 in FIG. 15). That is, the front surface W_{U1} of the upper wafer W_{U} is oriented downward. The inverting of the front and rear surfaces of the upper wafer W_{U} may be performed during the movement of the inverting mechanism 220 which will be described later.

Subsequently, the inverting mechanism 220 is moved to the upper chuck 230 side such that the upper wafer W_{U} is transferred from the inverting mechanism 220 to the upper chuck 230. The rear surface W_{U2} of the upper wafer W_{U} is adsorbed to the upper chuck 230 (Operation S5 in FIG. 15). At this time, all the vacuum pumps 241a, 241b and 241c are operated to adsorb the upper wafer W_{U} over all of the regions 230a, 230b and 230c of the upper chuck 230. The upper wafer W_{U} is on standby in the upper chuck 230 until the lower wafer W_{L} is transferred to the bonding device 41, which will be described later.

While the operations S1 to S5 as described above are being performed on the upper wafer W_{U}, the lower wafer W_{L} following that upper wafer W_{U} is processed. First, the lower wafer W_{L} is taken out of the cassette C_{L} by the wafer transfer unit 22 and subsequently, is transferred to the transition unit 50 of the processing station 3.

Subsequently, by the wafer transfer unit 61, the lower wafer W_{L} is transferred to the surface modification device 30 where the front surface W_{L1} of the lower wafer W_{L} is modified (Operation S6 in FIG. 15). The modification for the front surface W_{L1} of the lower wafer W_{L} to be performed in Operation S6 is the same as that in Operation S1.

Thereafter, by the wafer transfer unit 61, the lower wafer W_{L} is transferred to the surface hydrophilization device 40 where the front surface W_{L1} of the lower wafer W_{L} is hydrophilized and cleaned (Operation S7 in FIG. 15). The hydrophilization and cleaning operations for the front surface W_{L1} of the lower wafer W_{L} to be performed in Operation S7 is the same as that in Operation S2, and therefore, a description thereof will be omitted to avoid repetition.

Thereafter, the lower wafer W_{L} is transferred to the bonding device 41 by the wafer transfer unit 61. In the bonding device 41, the lower wafer W_{L} is transferred to the position adjusting mechanism 210 by the wafer transfer body 202 via the transition 200. In the position adjusting mechanism 210, a horizontal orientation of the lower wafer W_{L} is adjusted (Operation S8 in FIG. 15).

Thereafter, by the wafer transfer body 202, the lower wafer W_{L} is transferred to the lower chuck 231 where the lower wafer W_{L} is adsorbed thereto (Operation S9 in FIG. 15). At this time, all the vacuum pumps 261a and 261b are operated to adsorb the lower wafer W_{L} over the regions 231a and 231b of the lower chuck 231. Thus, the rear surface W_{L2} of the lower wafer W_{L} is adsorbed to the lower chuck 231 and the front surface W_{L1} of the lower wafer W_{L} is oriented upward.

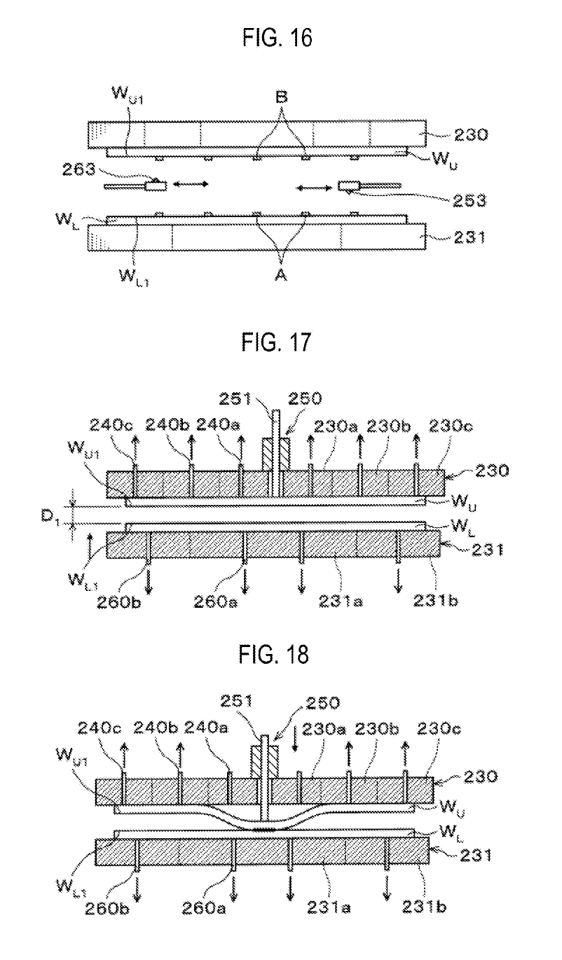

Subsequently, the horizontal directions of the upper wafer W_{U} held by the upper chuck 230 and the lower wafer W_{L} held by the lower chuck 231 are adjusted. As shown in FIG. 16, a plurality of (e.g., four or more) predetermined reference points A are formed on the front surface W_{L1} of the lower wafer W_{L}, and similarly, a plurality of (e.g., four or more) predetermined reference points B are formed on the front surface W_{U1} of the upper wafer W_{U}. Predetermined patterns formed on the wafers W_{U} and W_{L} may be used as the reference points A and B, respectively. Subsequently, the upper image pickup member 253 is horizontally moved to pick up an image of the front surface W_{L1} of the lower wafer W_{L}. Similarly, the lower image pickup member 263 is horizontally moved to pick up an image of the front surface W_{U1} of the upper wafer W_{U}. Thereafter, the horizontal position (including the horizontal orientation) of the lower wafer W_{L} is adjusted by the lower chuck 231 such that positions of the reference points A of the lower wafer W_{L} indicated on the picked-up image obtained at the upper image pickup member 253 coincide with positions of the reference points B of the upper wafer W_{U} indicated on the picked-up image obtained at the lower image pickup member 263. Specifically, the lower chuck 231 is horizontally moved by the chuck drive unit 234 to adjust the horizontal position of the lower wafer W_{L}. Thus, the horizontal positions of the upper wafer W_{U} and the lower wafer W_{L} are adjusted (Operation S10 in FIG. 15).

In addition, although the horizontal orientations of the wafers W_{U} and W_{L} are adjusted by the position adjusting mechanism 210 in Operations S3 and S8, the horizontal orientations may be finely adjusted even in Operation S10. While in Operation S10 of this embodiment, the predetermined patterns formed on the wafers W_{U} and W_{L} are used as the reference points A and B, other reference points may be used. As an example, peripheral portions and the notch portions of the wafers W_{U} and W_{L} may be used as the reference points.

Thereafter, as shown in FIG. 17, the lower chuck 231 is moved upward by the chuck drive unit 234 to place the lower wafer W_{L} at a predetermined position. In this embodiment, the lower wafer WL is placed such that a gap D₁ between the front surface W_{L1} of the lower wafer W_{L} and the front surface W_{U1} of the lower wafer W_{U} corresponds to a predetermined distance, e.g., 50 μm. In this way, the vertical positions of the upper wafer W_{U} and the lower wafer W_{L} are adjusted (Operation S11 in FIG. 15). In Operations S5 to S11, the upper wafer W_{U} is adsorbed over the entire regions 230a, 230b and 230c of the upper chuck 230. Similarly, in Operations S9 to S11, the lower wafer W_{L} is adsorbed over the entire regions 231a and 231b of the lower chuck 231.

Thereafter, the first vacuum pump 241a is deactivated to stop the adsorption of the upper wafer W_{U} by the first suction pipe 240a in the first region 230a, as shown in FIG. 18. At this time, the upper wafer W_{U} is adsorbed in only the second region 230b and the third region 230c. Subsequently, the pressing pin 251 of the pressing member 250 is moved downward to descend the upper wafer W_{U} while pressing the central portion of the upper wafer W_{U}. At this time, a load of, e.g., 200g, is applied to the pressing pin 251, wherein the load causes the pressing pin 251 to be moved by a distance of 70 μm in the absence of upper wafer W_{U}. Further, the pressing member 250 presses the central portion of the upper wafer W_{U} and the central portion of the lower wafer W_{L} in contact with each other (Operation S12 in FIG. 15).

Thus, bonding between the pressed central portions of the upper and lower wafers W_{U} and W_{L} begins (see a thick line indicated in FIG. 18). Specifically, since the front surface W_{U1} of the upper wafer W_{U} and the front surface W_{L1} of the lower wafer W_{L} have been modified in Operations S1 and S6, respectively, the Van der Waals force is caused between the front surfaces W_{U1} and W_{L1} so that the front surfaces W_{U1} and W_{L1} are bonded together. In addition, since the front surface W_{U1} of the upper wafer W_{U} and the front surface W_{L1} of the lower wafer W_{L} have been hydrophilized in Operations S2 and S7, respectively, hydrophilic groups between the front surfaces W_{U1} and W_{L1} form a hydrogen-bonding, which provides a strong bonding therebetween.

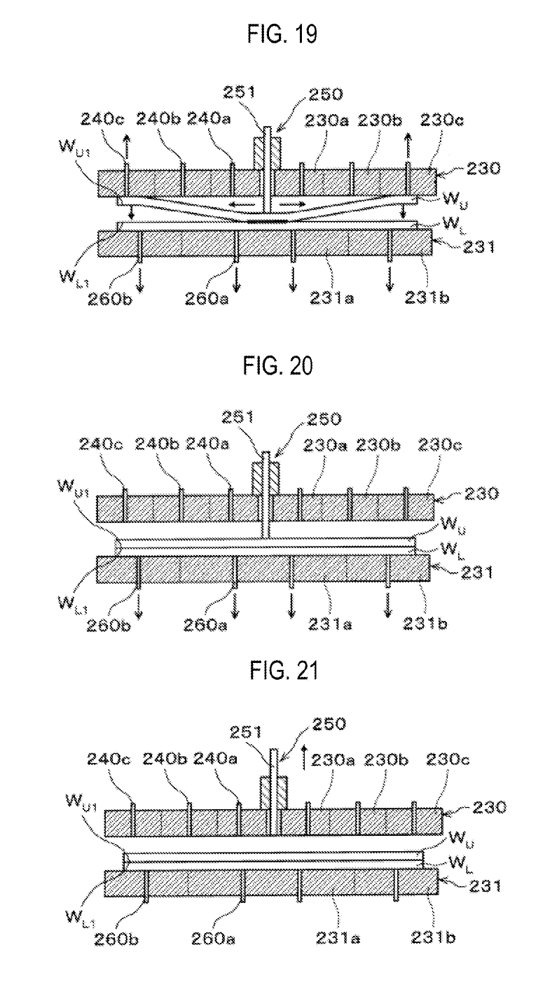

Thereafter, as shown in FIG. 19, in a state where the central portions of the upper and lower wafers W_{U} and W_{L} are pressed by the pressing member 250, the second vacuum pump 241b is deactivated to stop the adsorption of the upper wafer W_{U} by the second suction pipe 240b in the second region 230b. This allows the upper wafer W_{U} adsorbed in the second region 230b to be dropped on the lower wafer W_{L}. Subsequently, the third vacuum pump 241c is deactivated to stop the adsorption of the upper wafer W_{U} by the third suction pipe 240c in the third region 230c. In this way, the adsorption of the upper wafer W_{U} is gradually released from the central portion toward the periphery of the upper wafer W_{U} so that the upper wafer W_{U} is gradually dropped on the lower wafer W_{L}, which makes the upper wafer W_{U} and the lower wafer W_{L} to be brought into contact with each other. Further, the Van der Waals force between the front surfaces W_{U1} and W_{L1} and the bonding according to the hydrogen bonding therebetween are gradually expanded. Thus, as shown in FIG. 20, the front surface W_{U1} of the upper wafer W_{U} and the front surface W_{L1} of the lower wafer W_{L} are brought into contact with each other in whole so that the upper wafer W_{U} and the lower wafer W_{L} are bonded (Operation S13 in FIG. 15).

Thereafter, as shown in FIG. 21, the pressing member 250 is ascended up to the upper chuck 230. In addition, the adsorption of the lower wafer W_{L} by the lower chuck 231 through the suction pipes 260a and 260b is released such that the adsorption of the lower wafer W_{L} by the lower chuck 231 is released.

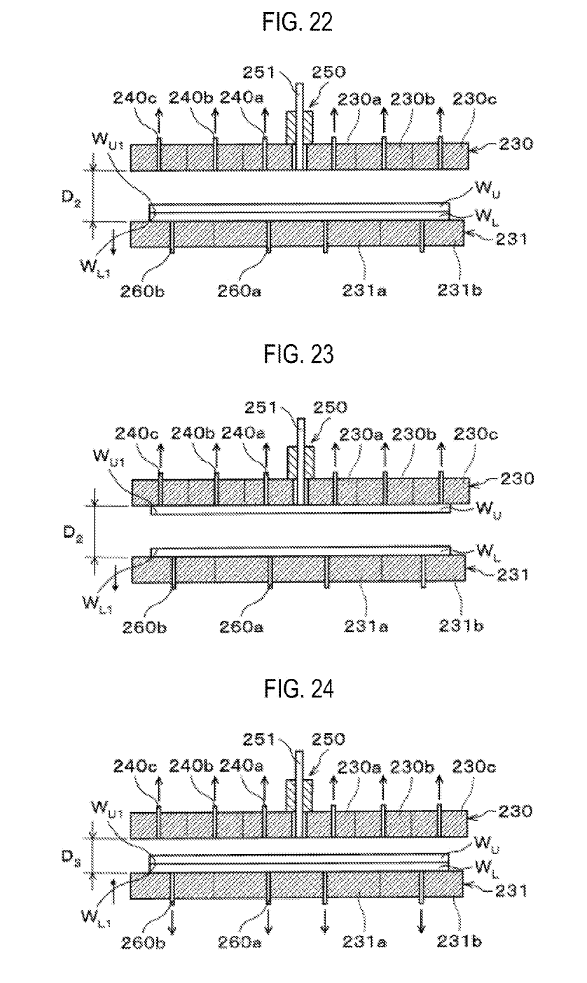

Subsequently, a sequence of determinations are made as to whether the upper wafer W_{U} exists on the upper chuck 230 and whether the bonding of the upper wafer W_{U} and the lower wafer W_{L} is acceptable. Specifically, as shown in FIGS. 22 and 23, the lower chuck 231 is moved downward to be disposed at a predetermined position. At this time, the lower wafer W_{L} is disposed such that a gap D₂ between the lower surface of the upper chuck 230 and the upper surface of the lower chuck 231 corresponds to a predetermined distance, e.g., 50 μm to 500 μm, such as 100 μm. Thereafter, the vacuum pumps 241a, 241b and 241c are operated to adsorb the upper wafer W_{U} through the suction pipes 240a, 240b and 240c over the entire regions 230a, 230b and 230c of the upper chuck 230. During the adsorption operation, the pressure measuring units 242a, 242b and 242c measure internal pressures of the suction pipes 240a, 240b and 240c, respectively. Based on the measurement results of the pressure measuring units 242a, 242b and 242c, it is determined whether the bonding of the upper wafer W_{U} and the lower wafer WL is acceptable (Operation S14 in FIG. 15).

More specifically, when the internal pressure of each of the suction pipes 240a, 240b and 240c falls within a range of, e.g., 10 to −450 mTorr, which is higher than a predetermined threshold value, e.g., −60 Pa (−450 mTorr), it is determined that the upper wafer W_{U} does not exist on the upper chuck 230, as shown in FIG. 22, and the bonding of the upper wafer W_{U} and the lower wafer W_{L} is normal. When the internal pressures of all the suction pipes 240a, 240b and 240c are higher than the predetermined threshold value, it may be determined that the bonding of the upper wafer W_{U} and the lower wafer W_{L} is normal. Specifically, when the internal pressure of each of the suction pipes 240a, 240b and 240c is measured to be, e.g., −53 Pa (−400 mTorr), it may be determined that the upper wafer W_{U} does not exist on the upper chuck 230.

On the other hand, when the internal pressures of the suction pipes 240a, 240b and 240c fall within a range of, e.g., −760 to −450 mTorr, which is equal to or lower than the predetermined threshold value, e.g., −60 Pa (−450 mTorr), it is determined that the upper wafer W_{U} exists on the upper chuck 230 as shown in FIG. 23 and the bonding of the upper wafer W_{U} and the lower wafer W_{L} is abnormal. When the internal pressure of any one of the suction pipes 240a, 240b and 240c is equal to or lower than the predetermined threshold value, it may be determined that the bonding of the upper wafer W_{U} and the lower wafer W_{L} is abnormal. Specifically, when the internal pressure of each of the suction pipes 240a, 240b and 240c is measured to be, e.g., −100 Pa (−750 mTorr), it may be determined that the upper wafer W_{U} exists on the upper chuck 230.

The upper wafer W_{U} and the lower wafer W_{L} are transferred to the transition unit 51 by the wafer transfer unit 61. Thereafter, the upper wafer W_{U} and the lower wafer W_{L} are collected by being transferred to the cassette C_{T} loaded on the specified cassette loading board 11 by the wafer transfer unit 22 of the carry-in/carry-out station 2.

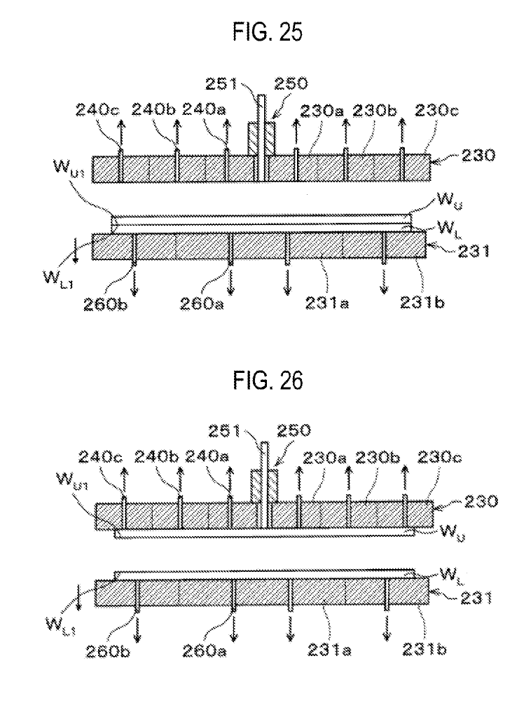

When it is determined in Operation S14 that the bonding of the upper wafer W_{U} and the lower wafer W_{L} is normal, a determination is made as to whether a bonding strength of the overlapped wafer W_{T} (obtained by bonding the upper wafer W_{U} and the lower wafer W_{L}) is acceptable. Specifically, as shown in FIG. 24, the lower chuck 231 is first moved upward to be disposed at a predetermined position. At this time, the lower wafer W_{L} is disposed such that a gap D₃ between the lower surface of the upper chuck 230 and the upper surface of the lower chuck 231 corresponds to the predetermined distance, e.g., 50 to 500 μm, such as 100 μm. Thereafter, the vacuum pumps 241a, 241b and 241c are operated to adsorb the upper wafer W_{U} by the suction pipes 240a, 240b and 240c over the entire regions 230a, 230b and 230c of the upper chuck 230. The lower chuck 231 adsorbs the lower wafer W_{L} over the entire the regions 231a and 231b. Subsequently, as shown in FIGS. 25 and 26, the lower chuck 231 is moved downward while maintaining the absorption operation over the entire regions 230a, 230b and 230c of the upper chuck 230. The pressure measuring units 242a, 242b and 242c measure the internal pressures of the suction pipes 240a, 240b and 240c, respectively. Based on the measurement results of the pressure measuring units 242a, 242b and 242c, it is determined whether the bonding strength of the upper wafer W_{U} and the lower wafer W_{L} is acceptable (Operation S15 in FIG. 15).

Specifically, when the internal pressure of each of the suction pipes 240a, 240b and 240c falls within the range of, e.g., 10 to −450 mTorr, which is higher than the predetermined threshold value, e.g., −60 Pa (−450 mTorr), it is determined that the upper wafer W_{U} is not adsorbed to the upper chuck 230 as shown in FIG. 25 and the bonding strength of the upper wafer W_{U} and the lower wafer W_{L} is normal. When the internal pressures of all the suction pipes 240a, 240b and 240c are higher than the predetermined threshold value, it may be determined that the bonding strength of the upper wafer W_{U} and the lower wafer W_{L} is normal. More specifically, when the internal pressure of each of the suction pipes 240a, 240b and 240c is measured to be, e.g., −53 Pa (−400 mTorr), it may be determined that the upper wafer W_{U} is not adsorbed to the upper chuck 230.

On the other hand, when the internal pressures of the suction pipes 240a, 240b and 240c fall within the range of, e.g., −760 to −450 mTorr, which is equal to or lower than the predetermined threshold value, e.g., −60 Pa (−450 mTorr), it is determined that the upper wafer W_{U} is adsorbed to the upper chuck 230 as shown in FIG. 26 and the bonding strength of the upper wafer W_{U} and the lower wafer W_{L} is abnormal. Even when the internal pressure of any one of the suction pipes 240a, 240b and 240c is equal to or lower than the predetermined threshold value, it may be determined that the bonding strength of the upper wafer W_{U} and the lower wafer W_{L} is abnormal. Specifically, when the internal pressure of each of the suction pipes 240a, 240b and 240c is measured to be, e.g., −100 Pa (−750 mTorr), it may be determined that the upper wafer W_{U} is adsorbed to the upper chuck 230.

The upper wafer W_{U} and the lower wafer W_{L}, the bonding strength of which is determined to be abnormal in Operation S15, are transferred to the transition unit 51 by the wafer transfer unit 61. Thereafter, the upper wafer W_{U} and the lower wafer W_{L} are collected by being transferred to the cassette C_{T} loaded on the specified cassette loading board 11 by the wafer transfer unit 22 of the carry-in/carry-out station 2.

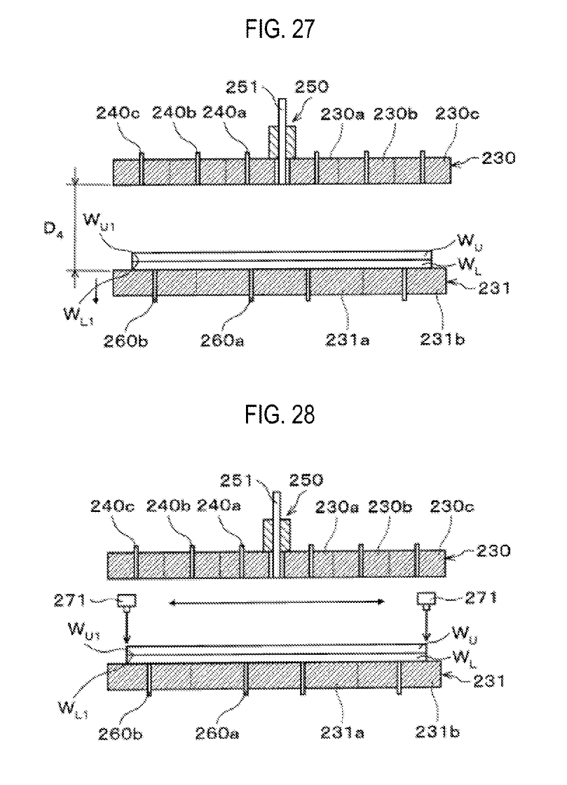

Subsequently, when the bonding strength of the overlapped wafer W_{T} (obtained by bonding the upper wafer W_{U} and the lower wafer W_{L}) is determined to be normal in Operation S15, it is determined whether a bonding position of the upper wafer W_{U} and the lower wafer W_{L} is acceptable. Specifically, as shown in FIG. 27, the lower chuck 231 is first moved downward to be disposed at a predetermined position. At this time, the lower wafer W_{L} is disposed such that a gap D₄ between the lower surface of the upper chuck 230 and the upper surface of the lower chuck 231 corresponds to the predetermined distance, e.g., 50 μm to 500 μm, such as 100 μm. Thereafter, as shown in FIG. 28, an image of the outer periphery of the overlapped wafer W_{T} held by the lower chuck 231 is picked up by the image pickup device 271 at, e.g., three points. Subsequently, the measuring unit 270 measures the outer diameter of the overlapped wafer W_{T}. Based on the measurement result of the outer diameter of the overlapped wafer W_{T}, determination is made as to whether the bonding position of the upper wafer W_{U} and the lower wafer W_{L} is acceptable (Operation S16 in FIG. 15).

Specifically, when the outer diameter of the overlapped wafer W_{T} measured at the measuring unit 270 is less than a predetermined threshold value, e.g., 300. mm (300 mm+200 μm), it is determined that the bonding position of the upper wafer W_{U} and the lower wafer W_{L} is normal. The predetermined threshold value is a value obtained by adding a tolerance of 200 um to the outer diameter 300 mm of the upper wafer W_{U} and the lower wafer W_{L}. In this embodiment, the tolerance of a misalignment between the upper wafer W_{U} and the lower wafer W_{L} is set to be 200 μm.

When the outer diameter of the overlapped wafer W_{T} measured at the measuring unit 270 is equal to or greater than the predetermined threshold value, e.g., 300.2 mm (300 mm+200 μm), it is determined that the bonding position of the upper wafer W_{U} and the lower wafer W_{L} is abnormal. As described above, the predetermined threshold value is a value in which the tolerance of the misalignment between the upper wafer W_{U} and the lower wafer W_{L} is 200 μm.

In the bonding system 1, the overlapped wafer W_{T}, the bonding strength of which is determined to be abnormal in Operation S16, is collected. At this time, when the outer diameter of the overlapped wafer W_{T} measured at the measuring unit 270 is less than a predetermined threshold value, e.g., 301 mm (300 mm+1 mm), that is, when the outer diameter of the overlapped wafer W_{T} is equal to or greater than 300.2 mm and less than 301 mm, the overlapped wafer W_{T} is collected through the use of the transfer system of the bonding system 1. Specifically, the overlapped wafer W_{T} is transferred to the transition unit 51 by the wafer transfer unit 61 and subsequently, is collected by being transferred to the cassette C_{T} loaded on the specified cassette loading board 11 by the wafer transfer unit 22 of the carry-in/carry-out station 2. The predetermined threshold value is a value obtained by adding a tolerance of 1 mm to the outer diameter 300 mm of the upper wafer W_{U} and the lower wafer W_{L}. In this embodiment, the size of the upper wafer W_{U} and the lower wafer W_{L} which can be transferred by the transfer arms of the wafer transfer units 22 and 61 is 301 mm.

On the other hand, when the outer diameter of the overlapped wafer W_{T} measured at the measuring unit 270 is equal to or greater than the predetermined threshold value, e.g., 301 mm (300 mm+1 mm), the bonding system 1 causes a warning device (not shown) to issue a warning. Pursuant to the warning, the overlapped wafer W_{T} is collected from the bonding system 1 by an external mechanism installed outside the bonding system 1. The external mechanism may be, e.g., a transfer unit equipped with a transfer arm. Alternatively, the overlapped wafer W_{T} may be manually collected. Further, the aforementioned warning device may be the control unit 300.

In this way, the overlapped wafer W_{T}, the bonding of which is determined to be normal in Operation S14, the bonding strength of which is determined to be normal in Operation S15 and the bonding position of which is determined to be normal in Operation S16, is transferred to the transition unit 51 by the wafer transfer unit 61 and subsequently, is transferred to the cassette C_{T} loaded on the specified cassette loading board 11 by the wafer transfer unit 22 of the carry-in/carry-out station 2. Thus, a series of bonding processes for the wafers W_{U} and W_{L} is finished.

According to some embodiments, the outer diameter of the overlapped wafer W_{T} is measured in Operation S 16. Based on the measurement result, it is determined whether the bonding position of the upper wafer W_{U} and the lower wafer W_{L} is acceptable. For example, when the bonding position is normal, the overlapped wafer W_{T} obtained by bonding the upper wafer W_{U} and the lower wafer W_{L} can be subjected to a subsequent process. When the bonding position is abnormal, the overlapped wafer W_{T} is collected without being subjected to the subsequent process. This prevents a transfer failure or a wafer damage from occurring, which makes it possible to smoothly perform a process for subsequent wafers W.

Further, when the bonding position of the upper wafer W_{U} and the lower wafer W_{L} is determined to be abnormal in Operation S16 and when the measurement result of the outer diameter of the overlapped wafer W_{T} is less than the predetermined value, the respective overlapped wafer W_{T} is collected by being transferred to the specified cassette C_{T} of the carry-in/carry-out station 2 by the wafer transfer units 22 and 61. On the other hand, when the measurement result of the outer diameter of the overlapped wafer W_{T} is equal to or greater than the predetermined value, the bonding system 1 issues the warning such that the respective overlapped wafer W_{T} is collected from the bonding system 1 by the external mechanism. That is, the overlapped wafer W_{T}, which is to be transferred by the transfer arms of the wafer transfer units 22 and 61, is designed to be collected using the transfer system of the bonding system 1, and the overlapped wafer W_{T}, which cannot be transferred by the transfer arms of the wafer transfer units 22 and 61, is designed to be collected using the external mechanism. With this configuration, it is possible to prevent a transfer failure or a wafer damage, thus smoothly performing processing for subsequent wafers W.

Further, it is determined in Operation S14 whether the bonding of the upper wafer W_{U} and the lower wafer W_{L} is acceptable based on the internal pressures of the suction pipes 240a, 240b and 240c. Further, it is determined in Operation S15 whether the bonding strength of the upper wafer W_{U} and the lower wafer W_{L} is acceptable based on the internal pressures of the suction pipes 240a, 240b and 240c. Further, it is determined in Operation S16 whether the bonding position of the upper wafer W_{U} and the lower wafer W_{L} is acceptable based on the measured outer diameter. Through a series of Operations S14, S15 and S16, since it is determined whether the bonding of the upper wafer W_{U} and the lower wafer W_{L} is acceptable, it is possible to determine the normality of the bonding of the upper wafer W_{U} and the lower wafer W_{L} in a reliable manner. This enables the subsequent wafers W to be processed more smoothly.

Further, in Operation S14 and S15, when the internal pressure of any one of the suction pipes 240a, 240b and 240c is equal to or less than the predetermined threshold value, it is determined that the bonding of the upper wafer W_{U} and the lower wafer W_{L} is abnormal. This makes it possible to more exactly inspect a bonding state of the upper wafer W_{U} and the lower wafer W_{L}, thus smoothly performing processing for the subsequent wafers W.

Further, the wafers W_{U} and W_{L} are bonded using the related devices in Operations S14 and S15. This eliminates the need to employ additional devices for performing Operation S14 and S15. Accordingly, it is possible to efficiently perform the determination of the normality of the bonding.

Further, in Operation S13, the adsorption of the upper wafer W_{U} is gradually released from the center toward the outer periphery the upper wafer W_{U} while the centers of the upper wafer W_{U} and the lower wafer W_{L} are brought into contact with each other and are pressed against each other by the pressing member 250. By doing so, the upper wafer W_{U} is gradually brought into contact with the lower wafer W_{L} so that the upper wafer W_{U} and the lower wafer W_{L} are bonded together. With this configuration, when the adsorption of the upper wafer W_{U} is released in the regions 230b and 230c, the center of the upper wafer W_{U} and the center of the lower wafer W_{L} are brought into contact with each other and are pressed against each other. As such, even if air exists between the upper wafer W_{U} and the lower wafer W_{L}, there is no possibility that the upper wafer W_{U} and the lower wafer W_{L} is horizontally misaligned to each other. Accordingly, it is possible to stably perform the bonding of the wafers W_{U} and W_{L}.

Further, in Operation S13, the upper wafer W_{U} is gradually brought into contact with the lower wafer W_{L} from the center toward the outer periphery of the upper wafer W_{U}. As such, even if air (which may result in voids) exists between the upper wafer W_{U} and the lower wafer W_{L}, the air always exists outward from a position where the upper wafer W_{U} and the lower wafer W_{L} are brought into contact with each other. This makes it possible to discharge the air outward from the center between the wafers W_{U} and W_{L}. Accordingly, it is possible to restrain voids from being generated between the wafers W_{U} and W_{L}, thus stably bonding the wafers W_{U} and W_{L} together.

Further, according to some embodiments, it is not necessary that the atmosphere for bonding the wafers W_{U} and W_{L} is kept in a vacuum atmosphere. This makes it possible to efficiently perform the bonding of the wafers W_{U} and W_{L} in a short period of time, thus improving throughput of the wafer bonding process.

Further, the stopper members 262 are disposed along the outer periphery of the lower chuck 231. This prevents the wafer W_{U} (or W_{L}) or the overlapped wafer W_{T} from jumping out or slipping from the lower chuck 231.

In some embodiments, the bonding device 41 is configured to include the position adjusting mechanism 210 configured to adjust the horizontal orientations of the wafers W_{U} and W_{L} and the inverting mechanism 220 configured to invert the front and rear surfaces of the upper wafer W_{U}, in addition to the upper chuck 230 and the lower chuck 231 which are used in bonding the wafers W_{U} and W_{L}. This makes it possible to efficiently perform the bonding of the wafers W_{U} and W_{L} in a single apparatus. Furthermore, the bonding system 1 is configured to include the surface modification device 30 configured to modify the front surfaces W_{U1} and W_{L1} of the wafers W_{U} and W_{L} and the surface hydrophilization device 40 configured to hydrophilize and clean the front surfaces W_{U1} and W_{L1} in addition to the bonding device 41. This makes it possible to efficiently perform the bonding of the wafers W_{U} and W_{L} in a single system. Accordingly, it is possible to further improve throughput of the wafer bonding process.

While in some embodiments, the upper image pickup member 253 configured to pick up the image of the lower wafer W_{L} and the image pickup unit 271 of the measuring unit 270 configured to pick up the image of the overlapped wafer W_{T} has been described to be installed independently of each other, only one of the upper image pickup member 253 and the image pickup unit 271 may be installed. In other words, both the images of the lower wafer W_{L} and the overlapped wafer W_{T} may be picked up by the upper image pickup member 253. Further, both the images of the lower wafer W_{L} and the overlapped wafer W_{T} may be picked up by the image pickup device 271. In this configuration, one of the upper image pickup member 253 and the image pickup unit 271 may be omitted, which makes it possible to simplify the bonding apparatus.

While in some embodiments, in Operation S14 and S15, the normality of the bonding and the normality of the bonding strength of the upper wafer W_{U} and the lower wafer W_{L} has been described to be determined based on the internal pressures of the suction pipes 240a, 240b and 240c, these determinations may be performed based on other parameters. As an example, the normality of the bonding and the normality of the bonding strength may be determined based on a flow rate of air flowing through the suction pipes 240a, 240b and 240c, a pressure or a flow rate of air discharged from the vacuum pumps 241a, 241b and 241c, a current value of a motor for operating the vacuum pumps 241a, 241b and 241c, or the like.

While in some embodiments, the chuck drive unit 234 has been described to move the lower chuck 231 in both the vertical and horizontal directions, the present invention is not limited thereto. In some embodiments, the upper chuck 230 may be configured to move in any one of the vertical and horizontal directions. Alternatively, both the upper chuck 230 and the lower chuck 231 may be configured to move the vertical and horizontal directions.

While certain embodiments have been described, these embodiments have been presented by way of example only, and are not intended to limit the scope of the inventions. Indeed, the novel methods and apparatuses described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. The present invention may be applied to other various substrates including a metal substrate, a flat panel display (FPD), a mask reticle for a photomask and so on.

### EXPLANATION OF REFERENCE NUMERALS

1 bonding system
2 carry-in/carry-out station
3 processing station
30 surface modification device
40 surface hydrophilization device
41 bonding device
60 wafer transfer region
201 transfer rail
202 wafer transfer body
210 position adjusting mechanism
220 inverting mechanism
230 upper chuck
230a, 230b, 230c region
231 lower chuck
233 shaft
234 chuck drive unit
240a, 240b, 240c suction pipe
241a, 241b, 241c vacuum pump
242a, 242b, 242c pressure measuring units
250 pressing member
262 stopper member
270 measuring unit
271 imaging member
300 control unit
W_{U} upper wafer
W_{U1} front surface
W_{L} lower wafer
W_{L1} front surface
W_{T} overlapped wafer

What is claimed is:

1. A method of bonding substrates having a same planar shape, comprising:
bonding a first substrate adsorbed to a lower surface of a first holding member and a second substrate adsorbed to an upper surface of a second holding member that is disposed below the first holding member; and
determining whether a bonding position of the first substrate and the second substrate is acceptable by measuring an outer diameter of an overlapped substrate obtained by bonding the first substrate and the second substrate,
wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal.

2. The method of claim 1, wherein the determining measures the outer diameter of the overlapped substrate by picking up an image of an outer periphery of the overlapped substrate.

3. The method of claim 1, further comprising: after the bonding and before the determining,
vertically moving the first holding member or the second holding member relative to each other;
disposing the first holding member and the second holding member at predetermined positions;
adsorbing the first substrate using a suction pipe of a suction mechanism installed in the first holding member; and
deciding whether the first substrate exists on the first holding member based on an internal pressure of the suction pipe to judge whether the bonding of the first substrate and the second substrate is acceptable,
wherein the deciding determines that, when the detected internal pressure of the suction pipe is higher than a predetermined threshold value, the bonding of the first substrate and the second substrate is normal, and when the detected internal pressure of the suction pipe is equal to or less than the predetermined threshold value, the bonding of the first substrate and the second substrate is abnormal.

4. The method of claim 3, further comprising: after the deciding and before the determining,
when it is determined in the deciding that the first substrate is not adsorbed to the first holding member and the bonding of the first substrate and the second substrate is normal, vertically moving the first holding member or the second holding member relative to each other, disposing the first holding member and the second holding member in predetermined positions, causing the second holding member to adsorb the second substrate while performing an suction operation by the suction mechanism, and judging whether a bonding strength of the first substrate and the second substrate is acceptable based on the internal pressure of the suction pipe,
wherein the judging determines that, when the internal pressure of the suction pipe is higher than the predetermined threshold value, the bonding strength of the first substrate and the second substrate is normal, and when the internal pressure of the suction pipe is equal to or lower than the predetermined threshold value, the bonding strength of the first substrate and the second substrate is abnormal.

5. The method of claim 1, wherein the first holding member includes a plurality of regions which is partitioned from the center toward the outer periphery of the first holding member, and
wherein the first substrate is adsorbed in each of the plurality of partitioned regions.

6. The method of claim 1, wherein the bonding includes:
disposing the first substrate held by the first holding member and the second substrate held by the second holding member to face each other with a predetermined gap left therebetween;
pressing centers of the first substrate and the second substrate using a pressing member installed in the first holding member so that they are brought into contact with each other at the centers; and
gradually bonding the first substrate and second substrate from the center toward the outer periphery of the first substrate in a state where the centers of the first substrate and the second substrate are pressed against each other.

7. A bonding device of bonding substrates having the same planar shape, comprising:
a first holding member configured to hold a first substrate on its lower surface;
a second holding member disposed below the first holding member and configured to hold a second substrate on its upper surface;
a measuring unit configured to measure an outer diameter of an overlapped substrate obtained by bonding the first substrate and the second substrate; and
a control unit configured to determine whether a bonding of the first substrate and the second substrate is acceptable,
wherein the control unit controls the first holding member, the second holding member and the measuring unit to perform:
bonding the first substrate adsorbed to the lower surface of the first holding member and the second substrate adsorbed to the upper surface of the second holding member,
measuring an outer diameter of the overlapped substrate, and
determining whether a bonding position of the first substrate and the second substrate is acceptable based on the measurement result,
wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal.

8. The device of claim 7, wherein the measuring unit includes an image pickup member configured to pick up an image of an outer periphery of the overlapped substrate.

9. The device of claim 7, further comprising:
a suction mechanism installed in the first holding member and configured to adsorb the first substrate;
a suction pipe by which the first holding member and the suction mechanism are connected; and
an elevating mechanism configured to vertically move the first holding member or the second holding member relative to each other,
wherein the control unit controls the first holding member, the second holding member, the suction mechanism and the elevating mechanism to perform: after the bonding and before the determining,
vertically moving the first holding member or the second holding member relative to each other,
disposing the first holding member and the second holding member at predetermined positions,
adsorbing the first substrate using the suction mechanism; and
deciding whether the first substrate exists on the first holding member based on an internal pressure of the suction pipe to judge whether the bonding of the first substrate and the second substrate is acceptable,
wherein the deciding determines that, when the detected internal pressure of the suction pipe is higher than a predetermined threshold value, the bonding of the first substrate and the second substrate is normal, and when the detected internal pressure of the suction pipe is equal to or less than the predetermined threshold value, the bonding of the first substrate and the second substrate is abnormal.

10. The device of claim 9, wherein the control unit controls the first holding member, the second holding member, the suction mechanism and the elevating mechanism to perform: after the deciding and before the determining,
when it is determined in the deciding that the first substrate is not adsorbed to the first holding member and the bonding of the first substrate and the second substrate is normal, vertically moving the first holding member or the second holding member relative to each other, disposing the first holding member and the second holding member in predetermined positions, causing the second holding member to adsorb the second substrate while performing an suction operation by the suction mechanism, and judging whether a bonding strength of the first substrate and the second substrate based on the internal pressure of the suction pipe is acceptable,
wherein the judging determines that, when the internal pressure of the suction pipe is higher than the predetermined threshold value, the bonding strength of the first substrate and the second substrate is normal, and when the internal pressure of the suction pipe is equal to or lower than the predetermined threshold value, the bonding strength of the first substrate and the second substrate is abnormal.

11. The device of claim 7, wherein the first holding member includes a plurality of regions which is partitioned from the center toward the outer periphery of the first holding member, and
wherein the first substrate is adsorbed in each of the plurality of partitioned regions.

12. The device of claim 7, further comprising:
a pressing member installed in the first holding member and configured to press the center of the first substrate.

13. The device of claim 7, wherein stopper members configured to guide the first substrate, the second substrate or the overlapped substrate are installed along an outer periphery of the second holding member.

14. The device of claim 7, further comprising:
a position adjusting mechanism configured to adjust a horizontal orientation of the first substrate or the second substrate;
an inverting mechanism configured to invert front and rear surfaces of the first substrate; and
a transfer mechanism configured to transfer the first substrate, the second substrate or the overlapped substrate inside the bonding device.

15. A bonding system provided with a bonding device of bonding substrates having the same planar shape, the bonding system comprising:
the bonding device including:
a first holding member configured to hold a first substrate on its lower surface, a second holding member disposed below the first holding member and configured to hold a second substrate on its upper surface,
a measuring unit configured to measure an outer diameter of an overlapped substrate obtained by bonding the first substrate and the second substrate, and
a control unit configured to determine whether a bonding of the first substrate and the second substrate is acceptable
the control unit controls the first holding member, the second holding member and the measuring unit to perform:
bonding the first substrate adsorbed to the lower surface of the first holding member and the second substrate adsorbed to the upper surface of the second holding member,
measuring an outer diameter of the overlapped substrate, and
determining whether a bonding position of the first substrate and the second substrate is acceptable based on the measurement result,
wherein the determining decides that, when the measurement result is less than a predetermined threshold value, the bonding position of the first substrate and the second substrate is normal, and when the measurement result is equal to or greater than the predetermined threshold value, the bonding position of the first substrate and the second substrate is abnormal;
a processing station including the bonding device; and
a carry-in/carry-out station in which the first substrate, the second substrate or the overlapped substrate is accommodated and is carried into/out the processing station,
wherein the processing station includes:
a surface modification device configured to modify a front surface of the first substrate to be bonded or a front surface of the second substrate to be bonded, a surface hydrophilization device configured to hydrophilize the front surface of the first substrate or the second substrate modified by the surface modification device, and
a transfer zone in which the first substrate, the second substrate or the overlapped substrate is transferred between the surface modification device, the surface hydrophilization device and the bonding device,
wherein the bonding device is configured to bond the first substrate and the second substrate whose front surfaces are hydrophilized by the surface hydrophilization device.

16. The system of claim 15, wherein, in a case where the bonding position of the first substrate and the second substrate is determined to be abnormal in the determining
when the measurement result of the outer diameter of the overlapped substrate is less than a predetermined value, the overlapped substrate is collected by being transferred to the carry-in/carry-out station through the transfer zone; and
when the measurement result of the outer diameter of the overlapped substrate is equal to or greater than the predetermined value, a warning is issued such that the overlapped substrate is collected from the bonding system using an external mechanism installed outside the bonding system.
